(19) United States
(12) Patent Application Publication
(10) Pub. No.: US 2016/0037131 A1
(43) Pub. Date: Feb. 4, 2016

(54) REMOTE TRESPASSING DETECTION AND NOTIFICAITON SYSTEM AND METHOD

(71) Applicants: Sean BURNETT, Victoria (CA); Greg CARNEY, Victoria (CA); James P. GIBBS, Syracuse, NY (US)

(72) Inventors: Sean Burnett, Victoria, British Columbia (CA); Greg Carney, Victoria, British Columbia (CA); James P. Gibbs, Syracuse, NY (US)

(21) Appl. No.: 14/777,055

(22) PCT Filed: Mar. 15, 2013
(86) PCT No.: PCT/CA2013/050212

§ 371 Date: Sep. 15, 2015

(51) Int. Cl. H04N 7/18; H04L 12/58; G08B 13/22; H04W 4/14

(52) U.S. Cl. CPC H04N 7/18; H04W 4/14; H04L 51/04; G08B 13/22

(57) ABSTRACT

A trespass detection system for notifying a recipient of a possible trespass at a remote location is disclosed. The system comprises a low bandwidth satellite network, and a hand-portable base station positioned at the remote location and comprising a satellite transceiver for communicating with the low bandwidth satellite network, and an image capture sensor located proximate to the base station for capturing an image in response to an alarm trigger, the image capture sensor further comprising a processor for analyzing the captured image to identify a predetermined type of object and on identifying at least one of the predetermined type of object in the captured image, generating a contour image of the identified object, wherein the contour image is transmitted to the recipient via the base station and the satellite network.

### FIELD OF THE INVENTION

The present invention relates to a remote trespassing detection and notification system. In particular, the present invention relates to a network of remote base stations with attached sensors which communicate with a recipient via a low band width network of satellites.

### BACKGROUND OF THE INVENTION

Policing of activity in rural or remote locations such as deserts, large forests, mountainous regions and tundra is typically difficult and expensive, requiring a large number of personal, expensive equipment such as a helicopters and global communications such as satellites.

The prior art discloses systems which provide surveillance of such remote areas using live video and the like. One drawback of such systems is that they are supported by high speed data networks and video feeds which are typically not available in remote areas, thereby requiring installation, or consume large amounts of expensive satellite communications.

### SUMMARY OF THE INVENTION

In order to address the above and other drawbacks, there is disclosed a trespass detection system for notifying a recipient of a possible trespass at a remote location. The system comprises a low bandwidth satellite network, and a hand-portable base station positioned at the remote location and comprising a satellite transceiver for communicating with the low bandwidth satellite network, and an image capture sensor located proximate to the base station for capturing an image in response to an alarm trigger, the image capture sensor further comprising a processor for analyzing the captured image to identify a predetermined type of object and on identifying at least one of the predetermined type of object in the captured image, generating a contour image of the identified object, wherein the contour image is transmitted to the recipient via the base station and the satellite network.

There is also disclosed a method for compressing a captured high resolution color image of an object for subsequent transmission via a low bandwidth network. The method comprises converting the image to grayscale, blurring the image, adjusting a brightness threshold attribute of the blurred image to generate a line representative of a contour of the object, determining a number of data points necessary to characterize the line, wherein the blurring act and the adjusting act are iteratively repeated until the number of data points is below a predetermined level, and converting the line into a series of coordinate pairs.

Also, there is disclosed a trespass detection system for notifying a recipient of a possible trespass at a remote location. The system comprises a low bandwidth satellite network and a hand-portable base station positioned at the remote location and comprising a satellite transceiver for communicating with the low bandwidth satellite network and a sensor interface capable of communicating with a plurality of co-located sensors, each of the sensors for detecting one of a plurality of different alarm conditions. When one of the sensors detects a respective one of the alarm conditions, a notification is transmitted to the recipient via the low bandwidth satellite network.

### BRIEF DESCRIPTION OF THE DRAWINGS

In the appended drawings:

FIG. 1 provides a schematic diagram of a remote trespass detection and notification system in accordance with an illustrative embodiment of the present invention;

FIG. 2 provides a schematic diagram of a base station in accordance with an illustrative embodiment of the present invention;

FIG. 3 provides a schematic diagram of a solar powered power supply in accordance with an illustrative embodiment of the present invention;

FIG. 4 provides a schematic diagram of a camera sensor in accordance with an illustrative embodiment of the present invention;

FIG. 5 provides an illustration of captured contour images in accordance with an illustrative embodiment of the present invention;

FIG. 6 provides a flow chart of an image processing algorithm in accordance with an illustrative embodiment of the present invention; and

FIGS. 7A through 7H provide a series of images of a user interface for configuring and controlling a remote trespassing detection and notification system in accordance with an illustrative embodiment of the present invention.

### DESCRIPTION OF ILLUSTRATIVE EMBODIMENTS

The present invention is illustrated in further details by the following non-limiting examples.

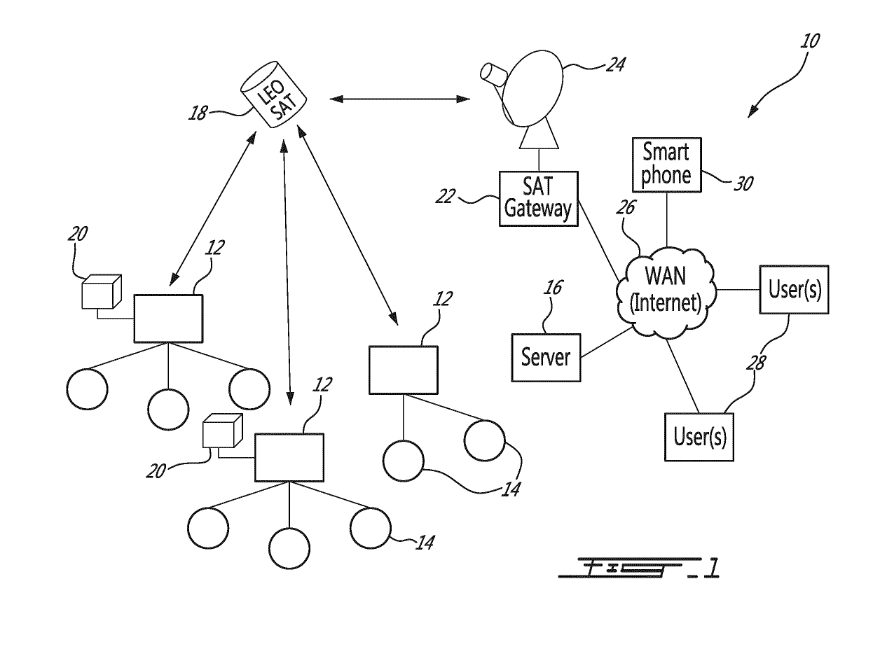

Referring now to FIG. 1, and in accordance with an illustrative embodiment of the present invention, a remote trespassing system, generally referred to using the reference numeral 10, will be described. The system comprises a remote sensing part, comprising a plurality of base stations 12 each interconnected with one or more sensors 14, and which communicate with a control and surveillance part comprising a server 16 via a low band width communication system such as a network of Low Earth Orbit (LEO) satellites 18, or the like. Each of the base stations 12 may be equipped with an onboard supply of power (not shown) such as batteries or the like or may be supplied by an external power source 20. The server 16 is interconnected with the satellites 18 via a gateway 22, ground station 24 and a Wide Area Network (WAN) 26 such as the Internet. Of note is that the base stations 12 and sensors 14 are of small size and light weight and are readily hand portable, such that a number of them may be carried, for example in a packsack or the like (not shown), by an installer to a remote location for installation.

Still referring to FIG. 1, as will be discussed in more detail below, one or more users can use their desktop PCs as in 28 to access the server 16, for example via a web browser (not shown) or the like to configure the base stations 12 to collect data from their respective attached sensors 14 or as to their current state of operation via the satellite network 18, 22 and 24. The server 16 can also be configured to generate one or more alarms which can be received by the users at their desktop PCs as in 28, via e-mail for example, or at their smartphone(s) 30, for example via SMS or e-mail or the like.

Still referring to FIG. 1, Illustratively, the LEO satellite system is the Iridium™ system, which, as known in the art, comprises a constellation of 66 operational satellites which operate in a low earth orbit about 780 kilometers (483 miles) above the surface of the earth. 11 equidistant satellites travel in each of six (6) different orbital planes which cross at the north and south and with an orbit duration of about 100 minutes. Each satellite projects up to 48 spot beams at the Earth's surface providing an overall foot print of about 2800 miles in diameter. Coverage between satellites overlaps such that overall coverage of the Iridium™ system is seamless.

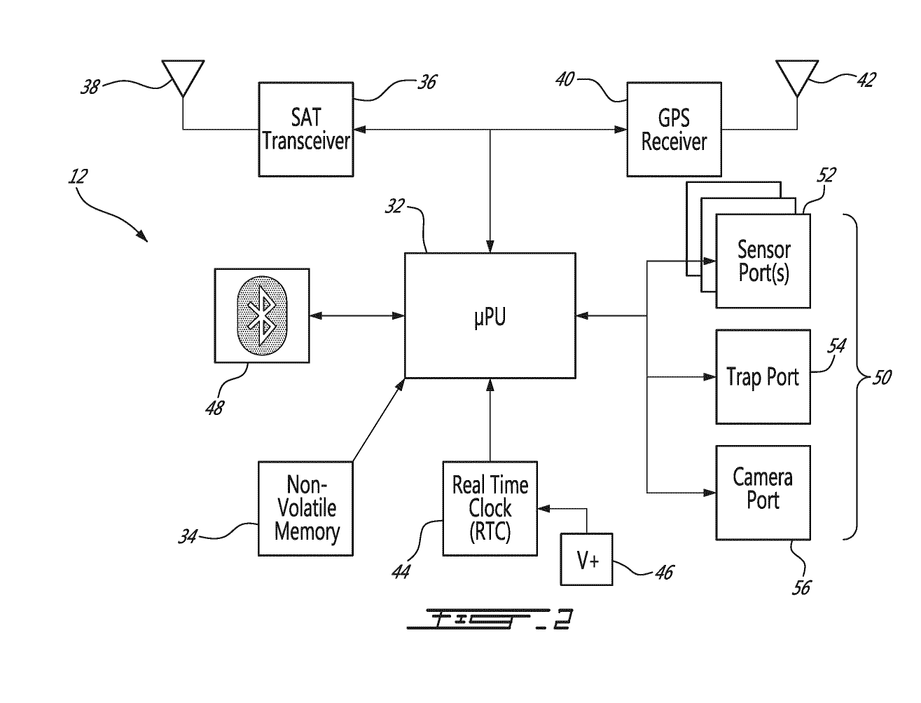

Referring now to FIG. 2, each base station is typically comprised of a microprocessor/controller 32 and an associated non-volatile memory 34 such as a flash card or EEPROM or the like for program and data storage. A satellite transceiver 36, such as the Iridium™ 9602 short burst data transceiver and associated satellite antenna 38, such as a whip antenna or the like is also provided for communicating with the Iridium™ system. Additionally, a GPS receiver 40 and its associated GPS antenna 42 is provided for determining position of the base station 12. A real time clock (RTC) 44 is provided for generating an accurate clock signal which is used to time stamp data acquired from the various attached sensors and the like, and as will be discussed in more detail below, scheduling hibernation, “heartbeat” messaging and certain other system timing events. In this regard, the RTC 44 includes its own dedicated source of power 46 such as a small coin cell battery or the like. Optionally, a Bluetooth™ interface 48 is provided for near field wireless communications with other external Bluetooth™ enabled devices, such as cellphones, personal computers, sensors, etc., thereby providing, for example, a convenient alternative interface for configuring the device. In a particular embodiment the satellite antenna 38 and/or the GPS antenna 42 may be external to the base station 12, such that the base station may be buried, for example, thereby improving its concealment while maintain the strength of communications via satellite and GPS reception.

Still referring to FIG. 2, a plurality of sensor interfaces as in 50 are also provided such that base station can collect data regarding its sensed environment. In particular, and as will be discussed in more detailed below, a plurality of general sensor ports as in 52 can be provided, as well as a trap port 54 and a camera port 56. The ports as in 50 typically provide a variety of different outputs to supply diverse sensors requiring different supply voltages as well as a bidirectional data interface for the transmission of control data and the reception of sensed data and data as to the status of the sensor, if available.

Still referring to FIG. 2, operation of the ports as in 50 will vary dependent on the type of sensor attached. For example, in a basic configuration one pin of the interface is a simple high/low logic output used to indicate to the device a triggering/disconnect event or a normal status. For more sophisticated sensors, for example when using a camera or the like, configuration and image transmission capabilities are provided.

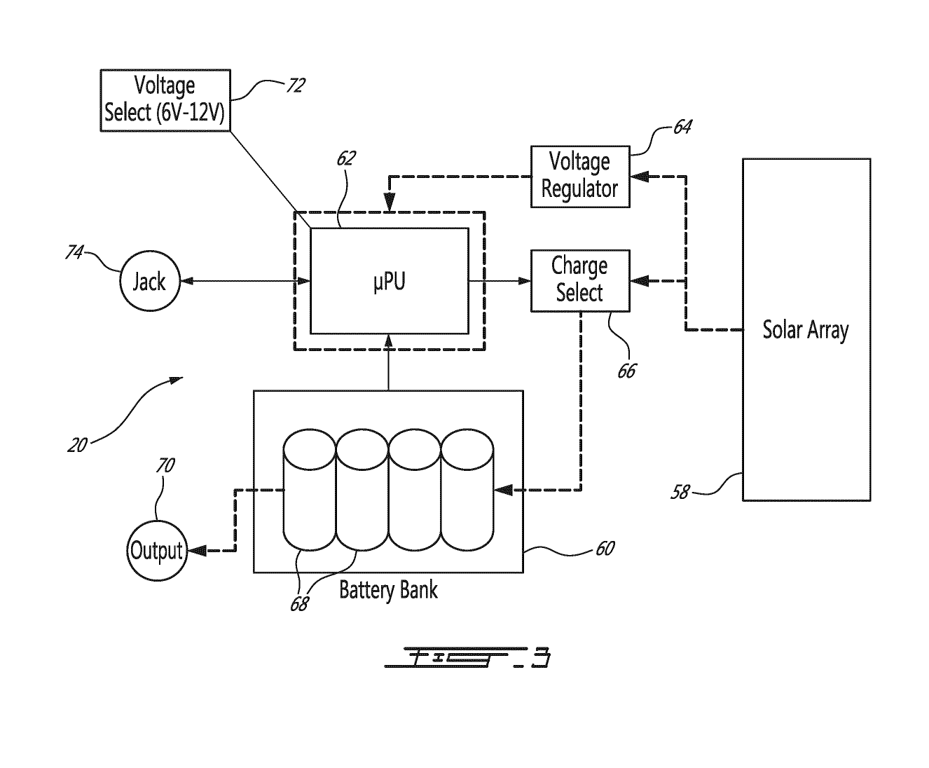

Referring now to FIG. 3, the external power source 20 comprises a solar array 58 which charges a battery bank 60 and provides operating current for microprocessor/controller 62 via a voltage regulator 64. In order to prevent overcharging of the battery bank 60, a charge select circuit 66, for example a relay, is provided which is controlled by the microprocessor 62 using software programs stored in a flash memory (not shown) within the microprocessor 62 and based on a level of charge of the batteries 68 sensed by the microprocessor 62. Correct operation of the charge select circuit 66 ensures that the battery bank is not overcharged and may also be used to prevent reverse current loss.

Power drawn off the batteries 68 is available to other devices via an output 70. In a particular embodiment a voltage select 72 is provided allowing the output voltage to be changed between 6 VDC and 12 VDC. Also in a particular embodiment a programming interface 74 is provided, for example for updating the software used by the microprocessor 62 to be updated. Illustratively, the programming interface 74 comprises a 1/8″ stereo jack. To provide for protection against effects of excessively cold conditions, the batteries 68 are preferably lead acid batteries.

Referring to FIG. 1, as discussed above a variety of sensors 14 can be used in combination with each of the base stations 12. Indeed, as discussed above the base station 12 typically comprises a plurality of ports for communicating with a plurality of sensors. Sensors include:
trap or gate switch sensors, which indicate to the base station 12 when an associated trap has been tripped or gate opened;
inductive loop sensors, for example buried in roadways, which can sense the presence, direction of travel and speed of large metal objects such as vehicles, and wherein a RENO BX4 Loop Detector and RENO A & E BX Series Vehicle Loop Detector Sensor provide an illustrative embodiment thereof;
temperature sensors which sense the ambient temperature of their surroundings and capture spikes in temperature, which typically indicate the presence of fire;
conventional motion sensors such as Infrared light barriers and trip wires;
sound detectors, for recording sounds and associated processing for analyzing particular sounds such as gunshots, vehicle motors and the like; and
cameras, for detecting images and associated processing for analyzing those images for the presence of particular objects.

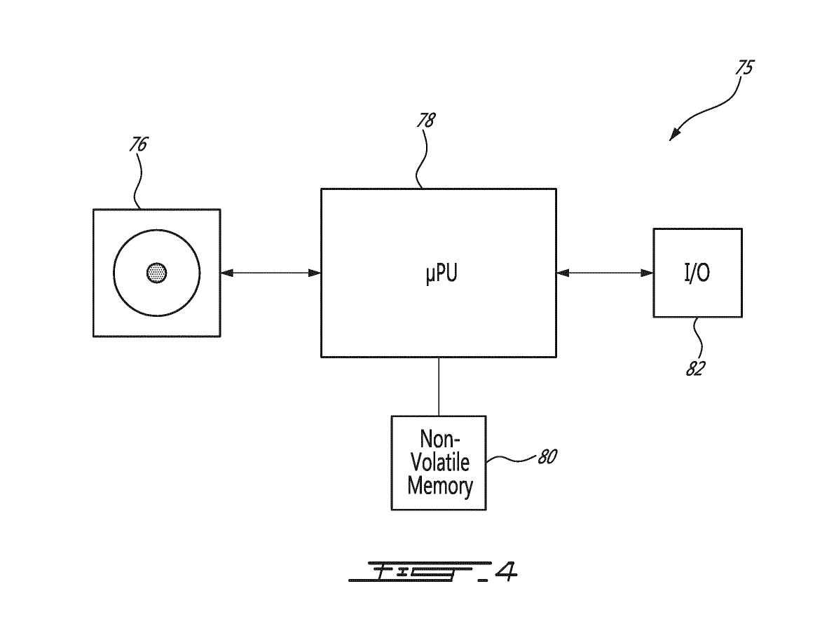

Referring now to FIG. 4, in an embodiment of a camera sensor 75, an image capture device 76 such as a CCD or the like captures images and video which are provided to a micro controller 78. Illustratively, the image capture device 76 is an off the shelf USB type camera and the micro controller 78 a small power efficient Advanced RISC Machine (ARM) mini-PC, such as an MK802 Mini PC, running Android™ or Linux™ or the like. Using applications stored in internal flash memory (not shown) or on an external non-volatile memory such as a microSD card or USB storage device or the like, the micro controller 78 receives images in the form of video from the image capture device 76, identifies objects recorded on the video, extracts still images from the video and then further process the extracted images such that they are suitable for uplinking via satellite. Processed images a transferred to the base station 12 via a serial interface 82.

Referring back to FIG. 1, as the system is foreseen largely for implementation in remote areas, and particular in the context of wildlife conservation, cabling between the base stations as in 12, their respective sensors as in 14 and power packs 20, if provided, typically comprise a foil shield which deters rodents and other small animals from chewing on the cables. Additionally, connectors used to interconnect the cables with the base stations as in 12, sensors as in 14 and power packs 20, if provided, is weatherproof but also field installable, for example connectors designed and manufactured to the NEMA 6P standard. Also, the respective enclosures of the base stations as in 12, sensors as in 14 and power packs 20 are NEMA rated and manufactured from a light rugged water resistant material such as polycarbonate or the like, and such that they can be buried in the ground for extended periods of time. In a particular embodiment the enclosures are painted in camouflage to avoid detection.

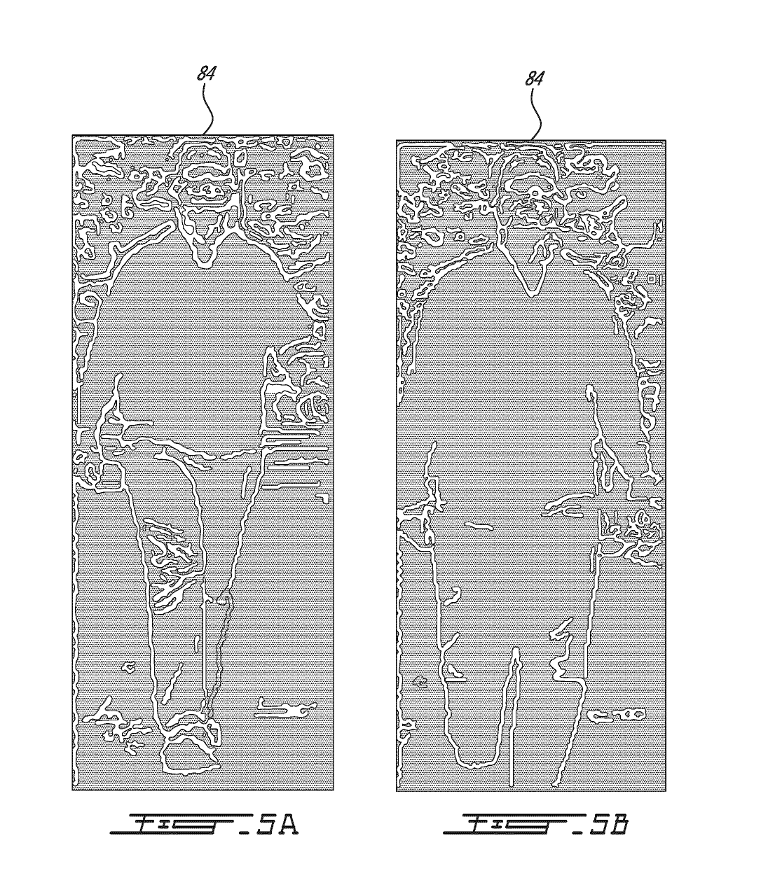

Referring again to FIG. 4, as discussed above, in order to reduce the amount of data required for transmission of an image of an object of interest identified using the camera sensor 74 via the LEO satellite system, an image compression application operating on the ARM microprocessor 78 is provided, for example stored in the external memory 80. Typically in response to an alarm raised by one or other of the sensors, or through detection of an image of interest by the ARM microprocessor itself, a high resolution still image is converted into a series of contour line points and curves which describe the edges of the objects detected. In practical terms, the converted image typically contains sufficient information to aid in the positive identification of the presence of a person within the image, but lacks sufficient detail to identify who that person actually is. Rather, the information is intended to corroborate sensor triggers and help determine remotely if a zone has indeed been breached. Referring to FIG. 5, illustrations of typical captured and compressed images as in 84 are provided.

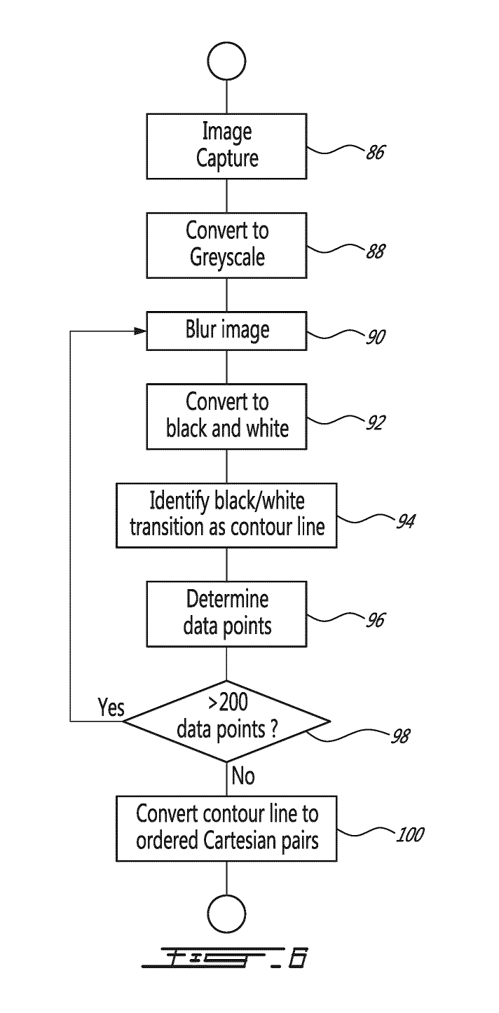

With reference to the flow chart at FIG. 6, the image capture and compression process will now be described. At 86 an image is captured which is expected to contain an object of interest. For example, this could be an image in which a person has triggered another sensor, or a frame in a video feed in which a large detected object is found to have frame-to-frame motion, perhaps containing a person's face. In a particular embodiment, identification of an object as comprising a person's face in a series of sequential frames (for example 7 frames out of 10) is used to flag a positive detection. At 88 the image is converted to grayscale and then the contour extracted by at 90 first blurring the image, at 92 adjusting the brightness threshold to convert the image to black and white, at 94 identifying the black and white transition edge as the contour line of the captured image, and then at 96 determining the number of points necessary to describe the contour line. At 98, the process is repeated iteratively until the number of points required to describe the contour line is below a predetermined number. Illustratively, it has been found that about 200 data points provide for a useful contour while minimizing the amount of data points necessary to describe the contour line. At 100, the contour line is subsequently converted to a Cartesian (X,Y) representation, i.e. the line is converted into a series of data points expressed as coordinate pairs X,Y. The coordinate pairs are packaged into a suitable data message for transmission via the LEO satellite system.

Referring back to FIG. 1, once received at the server 16, the coordinate pairs are unpacked from the message, the contours plotted and stored in a readable image file format. The contour line compression process compresses the useful information found in a surveillance image from approximately 1 megabyte to approximately 500 bytes (a compression ratio of approximately 2000:1) thereby making its transmission cost effective over a short burst data/LEO satellite.

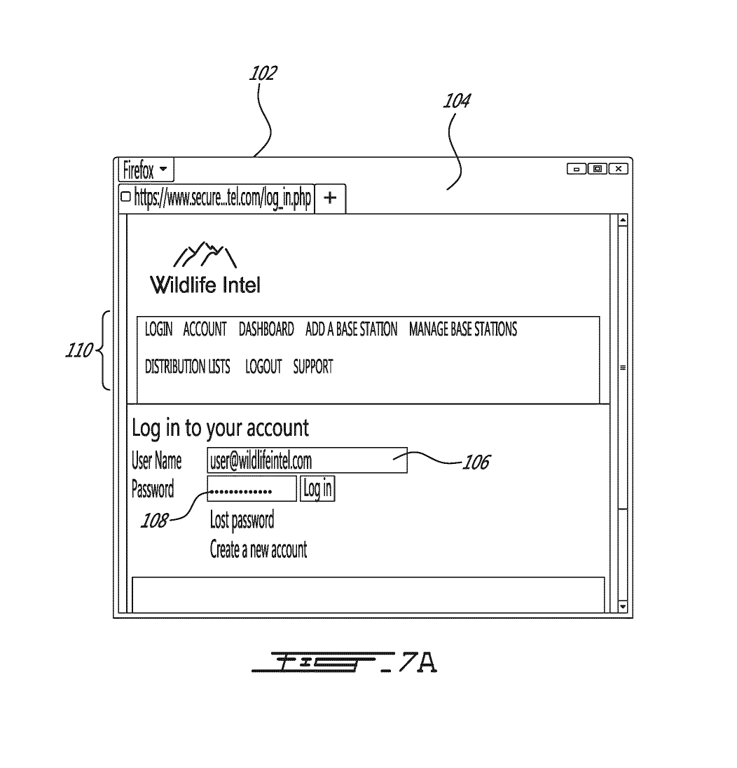

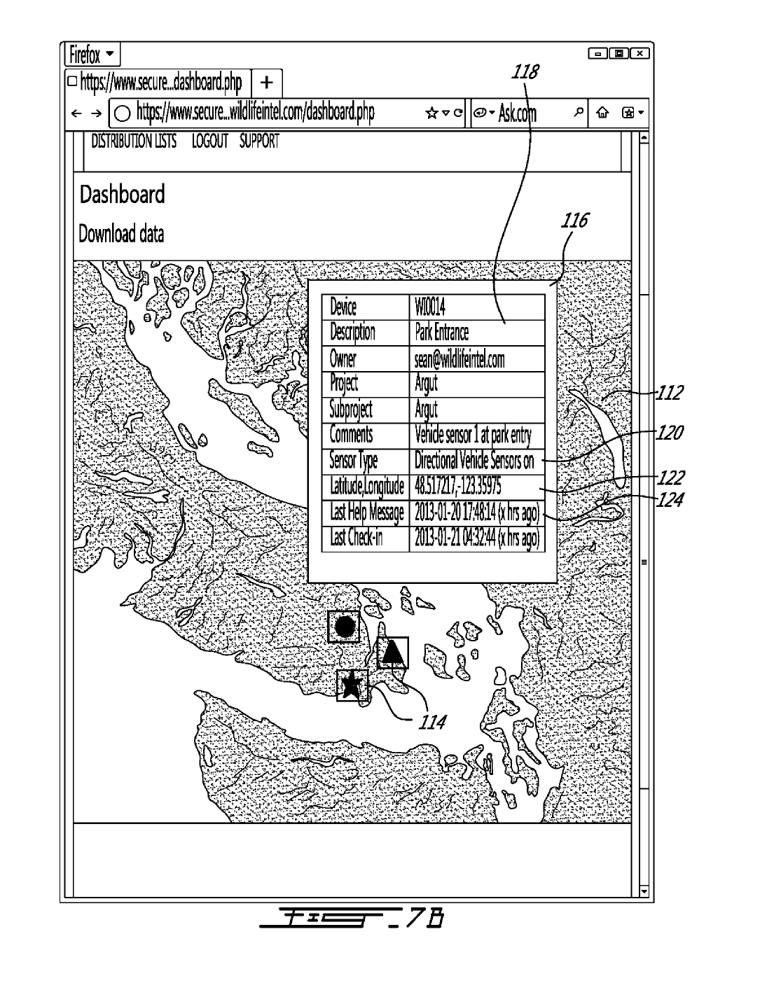

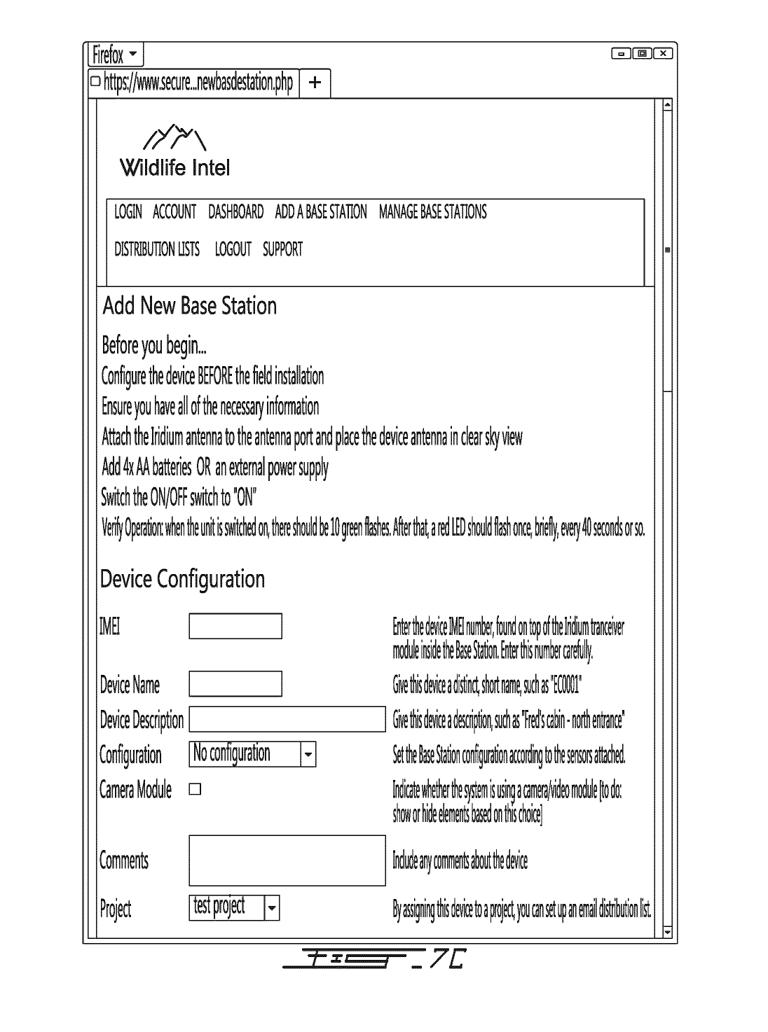

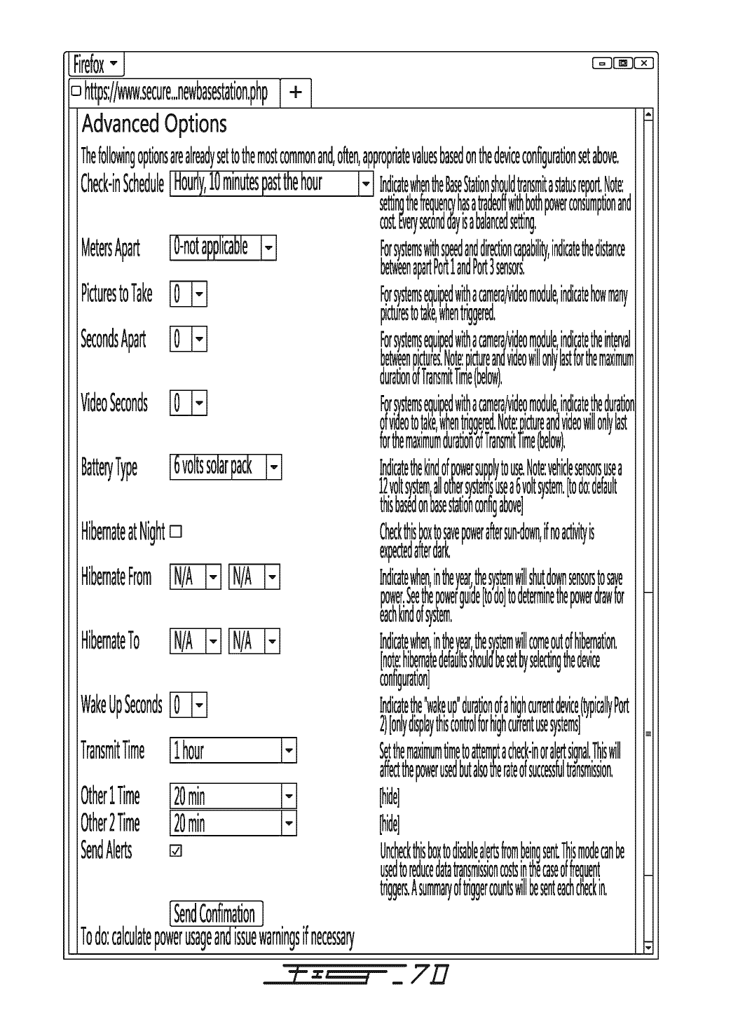

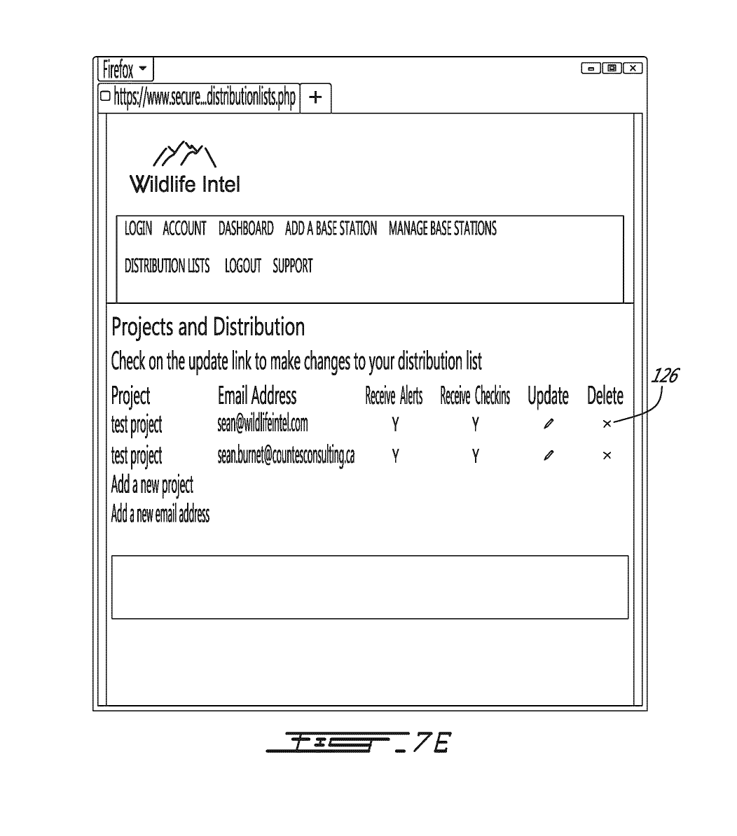

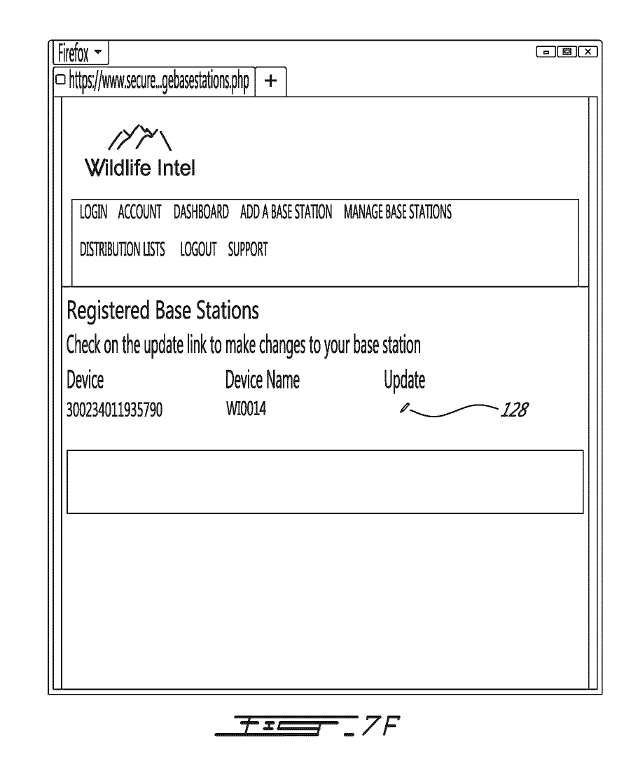

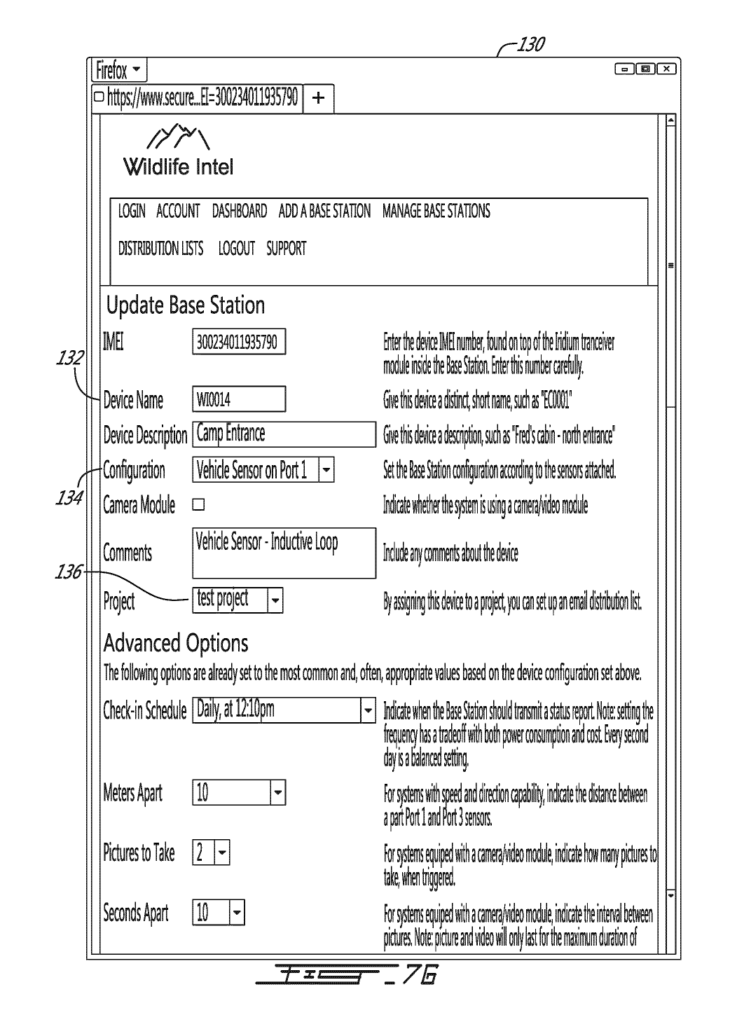

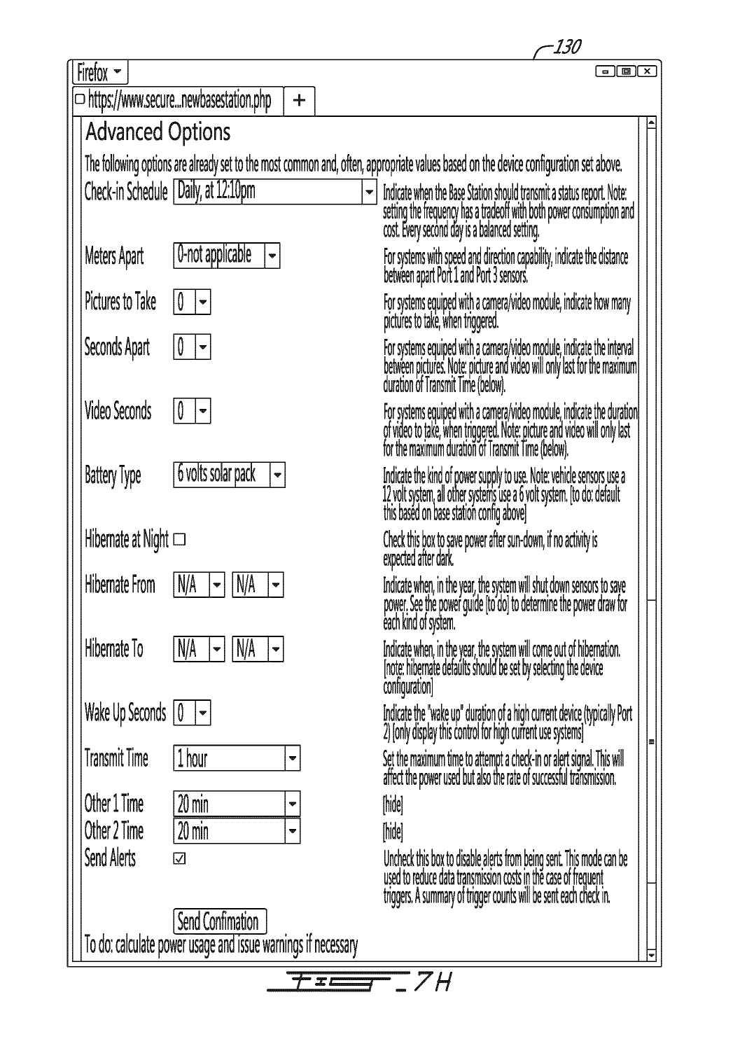

Referring now to FIG. 7A in addition to FIG. 1, as discussed above the users as in 28 illustratively access the server via a web interface 102. Initially, when accessing the server the user is presented with a login interface 104 where access is gained through the proper entry of a user name 106 (illustratively an e-mail address) and password 108. The user can subsequently move about the server by selecting one of the preferred services 110.

Referring to FIG. 7B in addition to FIG. 7A and FIG. 1, selection of the dashboard service provides the user with the display of a map 112 related to a region of interest and onto which one or more icons 114 indicating the presence of a base station 12 and associated sensors as in 14. In a particular embodiment the icons as in 114 can change color or exhibit behavior indicating the presence of an alarm condition. For example, recently triggered base stations are illustratively shown by icons differentiated by color and/or movement. By selecting a particular icon as in 114 using the cursor (not shown) or the like the user can retrieve information 116 related to the base station 12 and sensors 14 within which the icon as in 114 is associated, for example identification 118, type 120, location (in latitude and longitude) 122 and time last message was sent to the server 124. The dashboard service also provides other information such as a description of the base station 12, the project and subproject that the base station 12 is associated with, any particular comments regarding the base station 12 and its attached sensors and, as will be discussed in more detail below, the time of last check-in, if so selected.

Referring to FIG. 7C in addition to FIG. 1, new base stations as in 12 may be added and configured by selecting the “add a base station” service, which allows, for example, the base stations as in 12 to be assigned to projects such that reports they issue are directed to particular users, or groups of users as per a distribution list associated with the project, such as the distribution list 126 shown in FIG. 7E. Additional features which can be configure include the base station International Mobile Station Equipment Identity (IMEI) number, name, description, configuration of the base station as being associated with one or more of a trap sensor, a temperature sensor, a vehicle sensor (a single inductive loop), a vehicle speed and direction sensor (dual inductive loops), etc., the presence of a camera module as well as any comments. Referring to FIG. 7D, additional advanced options can also be configured, including the check-in schedule (a predetermined time of day when the base station is to transmit a status report, illustratively hourly, daily, weekly or the like), in the case of a vehicle speed and direction sensor, the meters the sensors are apart, the number of images to be acquired when an alarm is triggered, the interval between image capture, the length of video to be taken when an alarm is triggered, the type of associated power supplies (illustratively 6 or 12 volt battery of solar power supplies), a night hibernation attribute to indicate that the base station 12 should be powered down at night, a hibernation period between two dates, for example over winter, a wake up period for high current sensors (if attached), maximum time to attempt check-in and a send alert attribute de-selection of which indicates that the base station is not to send alerts.

Still referring to FIGS. 7C and 7D in addition to FIG. 1, once configured and operational the base station 12 and attached sensors 14 begin to transmit check-in messages and detect alarms and transit alerts, for example to a recipient's smartphone 30, for example using SMS or e-mail or the like, or to a user's desktop 28, for example via a web component of the server 16 or the like. A typical check-in message is as follows:

To: user1@user.com; user2@user.com; user3@user1.org
Subject: Check-in message from WI0014
Message Details
Base Station Name: WI0014 - Base station
Configuration: Trap Sensor
IMEI: 300234011935790
Owner: User
Project: park project
Message Serial Number: 93
Firmware Version: 40
Date/Time (UTC): 2012-12-26 06:14:20
Message Status: Transfer OK
Total Bytes: 11
Latitude: 48.523353
Longitude: −123.044297
CEP Radius: 77
Battery Level: 6.12 volts
Base Station not in hibernation
Trap Port Triggers Since Last Check-in: 3
Port 1 Triggers Since Last Check-in: 0
Port 2 Triggers Since Last Check-in: 0
Port 2 Triggers Since Last Check-in: 0
Pictures or Videos Since Last Check-in: 2
Alert Messages Since Last Check-in: 5
Trap Port Status: OK, ready
Port 1 Status: OK, ready
Port 2 Status: OK, ready
Port 3 Status: OK, ready
Wildlife Intel www.wildlifeintel.com
Dashboard: https://www.secure.wildlifeintel.com/log in.php

A typical alert message is as follows:

To: user1@user.com; user2@user.com; user3@user1.org
Subject: Alert message from WI0014
Message Details...
Base Station Name: WI0014 - first test Iridium base station
Configuration: Vehicle Speed and Direction Sensor
IMEI: 300234011935790
Owner: User
Project: park project
Message Serial Number: 93
Firmware Version: 40
Date/Time (UTC): 2012-12-26 06:14:20
Message Status: Transfer OK
Total Bytes: 11
Latitude: 48.523353
Longitude: −123.044297
Link to map...
Link to embedded image...
CEP Radius: 77
Speed of Travel: 12.6 km/h
Confidence Level: 100%
Port Triggered: Port 1 and 2
Direction of Travel: Outbound
Wildlife Intel
www.wildlifeintel.com
Dashboard: https://www.secure.wildlifeintel.com/log_in.php

Referring now to FIG. 7F in addition to FIG. 1, a list of base stations as in 12 which have been registered in the system can be viewed by selecting the “manage base stations” service. Configuration parameters of the base stations as in 12 can be modified by selecting the update icon 128 from the “manage base stations” service, which opens the Update base station service interface 130 as shown in FIG. 7G.

Still referring to FIG. 7G, the manage base stations interface 130 allows the user to modify both basic parameters, such as the device name 132, basic configuration 134 and related project 136, and (with reference to FIG. 7H) advanced options such as frame rate, video duration and the like. In particular, the manage base stations interface 130 allows the base station to be controlled such that it periodically generates a check-in message, as discussed above.

Although the present invention has been described hereinabove by way of specific embodiments thereof, it can be modified, without departing from the spirit and nature of the subject invention as defined in the appended claims.

What is claimed is:

1. A trespass detection system for notifying a recipient of a possible trespass at a remote location, the system comprising:
a low bandwidth satellite network; and
a hand-portable base station positioned at the remote location and comprising a satellite transceiver for communicating with said low bandwidth satellite network; and
an image capture sensor located proximate to said base station for capturing an image in response to an alarm trigger, said image capture sensor further comprising a processor for analyzing said captured image to identify a predetermined type of object and on identifying at least one of said predetermined type of object in said captured image, generating a contour image of said identified object;
wherein said contour image is transmitted to the recipient via said base station and said satellite network.

2. The trespass detection system of claim 1, wherein said image capture sensor captures a video stream and further wherein said alarm trigger comprises recognizing a movement in said captured video stream.

3. The trespass detection system of claim 1, further comprising a motion detector sensor located proximate to said base station and wherein said alarm trigger comprises sensing a motion with said motion sensor.

4. The trespass detection system of claim 3, wherein said motion sensor is selected from a group comprising a light barrier and a trip wire.

5. The trespass detection system of claim 1, comprising a plurality of said hand-portable base stations.

6. The trespass detection system of claim 1, further comprising a power supply for powering said base station and comprising a solar cell.

7. The trespass detection system of claim 1, wherein said predetermined type of object is a person.

8. The trespass detection system of claim 1, further comprising a server for receiving said transmitted contour image from said satellite network, encoding said contour image into a standard image file format and transmitting said encoded image to the recipient.

9. The trespass detection system of claim 8, wherein said encoded image is sent to the recipient as an attachment to an e-mail.

10. The trespass detection system of claim 8, wherein said encoded image is sent to the recipient as an SMS.

11. The trespass detection system of claim 8, further comprising a web server for displaying said base station as an icon on a map, and further wherein said icon changes its state when said base station in response to said alarm trigger.

12. The trespass detection system of claim 1, further comprising an external antenna in operational interconnection with said satellite transceiver and further wherein said base station is buried.

13. A method for compressing a captured high resolution color image of an object for subsequent transmission via a low bandwidth network, comprising:
converting the image to grayscale;
blurring the image;
adjusting a brightness threshold attribute of said blurred image to generate a line representative of a contour of the object;
determining a number of data points necessary to characterize said line, wherein said blurring act and said adjusting act are iteratively repeated until said number of data points is below a predetermined level; and
converting said line into a series of said data points.

14. The method of claim 13, wherein said converting act comprises converting said series of data points into a series of coordinate pairs.

15. The method of claim 13, wherein said predetermined level is between 100 and 500 data points.

16. The method of claim 15, wherein said predetermined level is 200 data points.

17. A trespass detection system for notifying a recipient of a possible trespass at a remote location, the system comprising:
a low bandwidth satellite network; and
a hand-portable base station positioned at the remote location and comprising a satellite transceiver for communicating with said low bandwidth satellite network and a sensor interface capable of communicating with a plurality of co-located sensors, each of said sensors for detecting one of a plurality of different alarm conditions;
wherein when one of said sensors detects a respective one of said alarm conditions, a notification is transmitted to said recipient via said low bandwidth satellite network.

18. The trespass detection system of claim 17, wherein one of sensors is camera capturing an image and wherein said respective alarm condition is the identification of a predetermined type of object within said image.

19. The trespass detection system of claim 18, wherein said predetermined object is a person and further wherein said notification includes an outline image of said person.

20. The trespass detection system of claim 17, wherein one of sensors is an inductive loop and said respective alarm condition is the presence of a vehicle in a vicinity of said inductive loop.

21. The trespass detection system of claim 17, wherein one of sensors is a trap sensor and said respective alarm condition is a tripping of a trap associated with said trap sensor.

22. The trespass detection system of claim 17, wherein one of sensors is a gate sensor and said respective alarm condition is an opening of a gate associated with said gate sensor.

23. The trespass detection system of claim 17, wherein one of sensors is a temperature sensor and said respective alarm condition is a fire indicated by a rapid rise in temperature.
